(19) United States
(12) Patent Application Publication
(10) Pub. No.: US 2007/0260011 A1
(43) Pub. Date: Nov. 8, 2007

(54) Roof patch composition

(76) Inventor: John R. Woods, Woodland Hills, CA (US)

Correspondence Address: PILLSBURY WINTHROP SHAW PITTMAN LLP, P.O BOX 10500, McLean, VA, 22102, US

(21) Appl. No.: 11/415,678

(22) Filed: May 2, 2006

(51) Int. Cl. C08G 18/08

(52) U.S. Cl. 524/589; 222/635

(57) ABSTRACT

A sprayable material used to repair roof surfaces or other like areas in the form of a sprayable composition includes an adhesive binder, one or more fillers, a suspension agent and optionally, a sealing agent, anti-freeze agent, anti-fungal agent and anti-mold agent. The material is stored and dispensed from a pressurized dispenser having a delivery nozzle. An aerosol system with a spray nozzle is included on the container for selective discharge of the sprayable composition directly onto a roof surface to be repaired, whether the roof surface is wet or dry.

### BACKGROUND

1. Field of the Invention

This invention relates generally to sprayable surface materials, and more particularly to a patch composition in liquid or semi-liquid form that is stored and dispensed from an air-tight pressurized container to be sprayed onto a roof or other similar surface to repair cracks or holes so that any leaks will be directly sealed.

2. Description of Related Art

It has been the conventional practice in the procedure of repairing roofs or other such surfaces to manually apply certain patching materials to the area of repair under certain conditions. For example, roof repairs are often discovered after raining has begun and leaks are revealed. In such situations, it would be desirable to immediately fix the leak and prevent further leakage. Conventional composition and tools, however, are generally not conducive to working during the rain or soon after the rain. Conventional compositions generally require the homeowner to wait until the rain ceases and the area of repair dries prior to applying the patching composition. Some conventional compositions require the area of repair to be cleaned before applying the composition.

Furthermore, conventional compositions often require the homeowner to use a trowel or separate tool to manually apply the patching material and fill the material into the crack or hole causing the leak. These conventional materials and methods of using are inconvenient and time-consuming and do not resolve the problem fast enough.

Therefore, there is a need for an aerosol composition that can be directly and immediately applied to an area of repair discovered on a roof or like surface, even when the surface may be wet. Additionally, there is a need for an aerosol assembly that can spray the composition sufficiently, thus eliminating the need for a separate tool for application or extra effort on the part of the user to apply the material.

### BRIEF SUMMARY OF THE INVENTION

In accordance with embodiments of the invention, an object of an embodiment of the present invention is to provide a patching composition that is sprayable from an aerosol container used for repairing cracks and holes in roof surfaces to stop or prevent leakages. The aerosol container used can be any commonly known in the art. The composition is stored and dispensed from a hand-held dispensing unit for spray-on and direct application of the material in a liquid or semi-liquid form onto the roof surface and does not require a separate tool to be used with application of the composition. The composition is applicable immediately to the roof surface, regardless of whether the surface is wet or dry.

Accordingly, the above problems and difficulties are avoided by the present invention, which generally provides a sprayable material that is stored and dispensed from a convenient aerosol dispenser including a pressurized container holding a quantity of the sprayable material in a liquid or semi-liquid condition so that upon depression of a dispensing nozzle, the composition will be discharged and directed to an area intended to receive the surface material. Whereas such a roof patch composition cannot be adequately sprayed from conventional nozzles, due to the large aggregates and components that can clog such nozzles, the present embodiments provide a nozzle assembly that is capable of doing so. The material flows through this dispensing nozzle and is applied as an aerosol spray, and is capable of hardening soon after application so as to fill in and patch the discovered leak. Thus, embodiments of the invention provide an efficient way to immediately fix discovered leakages on roofs with fewer steps than traditionally required with conventional roof patch compositions and associated tools. The composition may have the strength and durability to provide a permanent repair, but may also be used to temporarily patch a leak until a more appropriate or aesthetically matching repair can be made.

The roof leak composition comprises an adhesive binder, one or more fillers, a suspension agent, and optionally, silicon. Silicone may be included to serve as a sealing agent. The silicone retains a flexibility that is imparted to the composition so that the composition may move to fill in and expand in the cracks that the composition is applied to. Other materials with similar characteristics may be used in place of silicone. In addition, anti-freeze, anti-mold and anti-fungal additives may be incorporated to impart beneficial characteristics to the composition. The composition is contained in a hand-held aerosol container that includes a pressurized carrier for dispensing the composition, such as a solvent/propellant aerosol that mixes with the composition. Examples of propellants include, but are not limited to, hydrocarbon, dimethyl ether, propane, butane, carbon dioxide, nitrogen, compressed gas or any combination of the above said propellants or any other propellant used in the aerosol industry, such as hydrofluorocarbons.

An adhesive binder is used to impart physical strength to the area of repair after it dries and is attached to the structure. In order to adjust the finished appearance of the material, an adhesive binder may be added in an appropriate amount, which will increase the hardness and body. A filler may be composed of a mixture of any of calcium-carbonate (limestone), mica, silica, fine sand or clay may be used with embodiments to serve as extenders or bodifiers. Each individual filler may also be used alone. Silicone may be included to serve as a sealing agent. Further, alcohol and/or solvent may be added to effect faster drying times.

Color pigments may be included to impart a specific shade of color to the patch composition so that the applied composition may match the surrounding roof surface. In embodiments, the patch composition may be of a variety of common roof surface colors, depending on the specific pigment incorporated into the composition. For example, the patch composition may be gray, white, pink, black or brown. A user may select the color closest to that of the roof surface that needs to be repaired.

Lastly, anti-freeze, anti-mold and anti-fungal additives may be included so that the applied composition may better withstand the extreme elements that a rooftop is exposed to constantly. Anti-freeze may be added so that the composition does not freeze and crack in prolonged cold weather. Anti-mold and anti-fungal additives may be added to prevent mold and fungus from developing and growing on or near the area of repair. Because the growth of mold and fungus may weaken the roof surface after some time, including such additives is desirable to maintain integrity and strength of the repaired area.

### BRIEF DESCRIPTION OF THE DRAWINGS

For a better understanding of the present invention, reference may be had to the accompanying figures.

FIG. 1 is a perspective view of a system used to dispense a roof patch composition in accordance with an embodiment of the present invention;

FIG. 2 is a cross-sectional view of a repair of a roof surface using a roof patch composition in accordance with an embodiment of the present invention; and

FIG. 3 is a cross-sectional view of a valve assembly used to dispense a roof patch composition in accordance with an embodiment of the present invention.

### DETAILED DESCRIPTION OF THE INVENTION

In the following description, reference is made to the accompanying drawings which form a part hereof and which illustrate several embodiments of the present inventions. It is understood that other embodiments may be utilized and structural and operational changes may be made without departing from the scope of the present inventions.

Accordingly, the present invention generally provides a sprayable material that is stored and dispensed from a convenient aerosol dispenser including a pressurized container holding a quantity of the sprayable material in a liquid or semi-liquid condition so that upon depression of a dispensing nozzle, the composition will be discharged and directed to an area intended to receive the surface material. The material flows through the dispensing nozzle and is applied as an aerosol spray, and is capable of hardening soon after application so as to fill in and patch the discovered leak. Thus, embodiments of the invention provide an efficient way to immediately fix discovered leakages on roofs with fewer steps than traditionally required with conventional roof patch compositions and associated tools. The composition may have the strength and durability to provide a permanent repair, but may also be used to temporarily patch a leak until a more appropriate or aesthetically matching repair can be made.

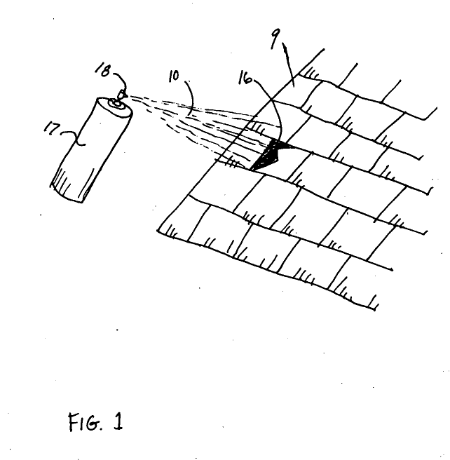

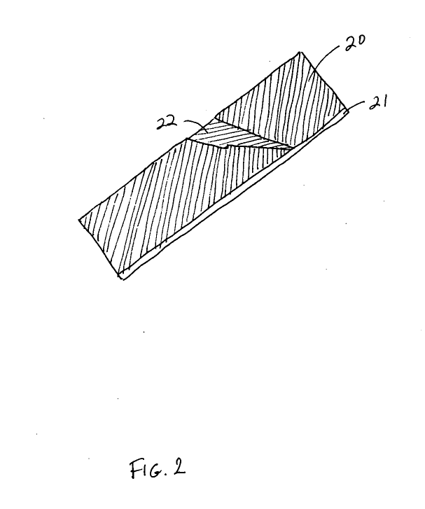

As shown in FIG. 1, and referring in detail to FIG. 2, the roof patch composition 10 discharged from an aerosol container 17 is illustrated as being applied to the area of repair 16 of the roof surface 9. In this manner, a coating is placed on the repair area 16 so as to seal the damage, such as a crack or hole. The material being applied is broadly indicated by numeral 10 which is contained within the aerosol container 17 and applied in the form of a spray in either liquid or semi-liquid condition.

In one embodiment of the present invention, shown in FIG. 1, application is achieved by depression of a spray nozzle or actuator 18 which permits discharge of the pressurized material carried within the container 17. Such an application of the material 10 occurs directly on the desired area 16 by the user who hand-carries the container 17 and operates the nozzle 18 on the site with one hand. Waste and loss of material is avoided since the discharge is under the control of the user through the application of the nozzle 18. Therefore, there is no residue or excess material that is not used which requires disposal. Furthermore, the material in the container is considered a finished product and does not require additives of any kind. The labeling on the container may provide identification numbers and laboratory information.

In an alternate embodiment of the present invention, the quick-dry aqueous material may be applied through the use of traditional spray dispensers as are known in the art.

Referring in detail to FIG. 2, a fragmentary view is shown of a typical piece of roof surface, such as for example a wood shingle, and is identified by the number 20. It is also shown that the roof surface 20 may be supported by boards or other means of support 21, although this is not always the case. The roof surface 20 has been damaged and a repair to the damaged area has been performed in the form of a patch 22. The composition is directly applied to the area of repair and the composition dries and solidifies into a patch 22 that seals and protects the damaged area. The composition adheres to the edges surrounding the damaged area as it dries. The combination of ingredients provide a strong and durable patch that can be used to permanently fix the damaged area or may also be used to temporarily patch a leak until a more appropriate or aesthetically matching repair can be made.

As illustrated in FIG. 1, the composition 10 can be applied directly to the roof surface 9 whether it is wet or dry. Under either condition, the composition 10 is able to dry and solidify into a strong patch to seal the damaged area. It is important to be able to repair a damaged roof when the damage is first discovered so that the weather conditions do not worsen the damage. Furthermore, when it is raining and the damaged area is leaking, it is highly useful to fix the area immediately with a composition that can be applied to and seal a wet surface.

Preferably, an example of the sprayable material comprises an adhesive binder such as acrylic resin, a filler such as calcium carbonate and/or clay, and a suspension agent such as METHOCEL. The composition may also include silicon. Other useful ingredients to include are anti-freeze and anti-fungal and anti-mold additives.

Color pigments may be included to impart a specific shade of color to the patch composition so that the applied composition may match the surrounding roof surface. In embodiments, the patch composition may be of a variety of common roof surface colors, depending on the specific pigment incorporated into the composition. For example, the patch composition may be gray, white, pink, black or brown. A user may select the color closest to the roof surface that needs to be repaired.

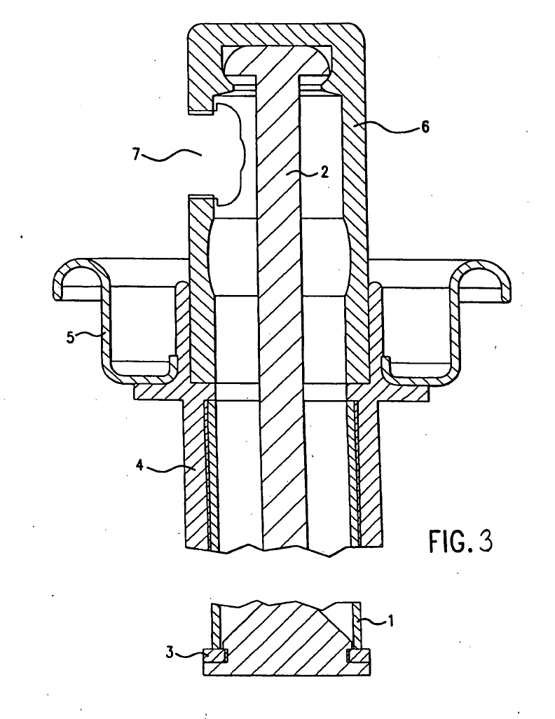

The composition is contained in a hand-held aerosol container that includes a pressurized carrier for dispensing the composition, such as a solvent/propellant aerosol that mixes with the composition. The propellant will act to push or propel the material 10 from the container. The propellant may be hydrocarbon, dimethyl ether, propane, butane, carbon dioxide, nitrogen, compressed gas or any combination of the above said propellants or any other propellant used in the aerosol industry, such as hydrofluorocarbons. However, the propellant is preferably a VOC propellant, and most preferably a dimethyl ether (DME) propellant.

Whereas such a patch composition cannot be adequately sprayed from conventional nozzles, due to the large aggregates and components that can clog such nozzles, the present embodiments provide a nozzle assembly that is capable of doing so. In FIG. 3, there is illustrated a valve assembly to be used with the container in dispensing the roof patch composition, in accordance with an embodiment of the present invention. Embodiments of this valve assembly are further disclosed in U.S. Pat. No. 6,415,964 to Woods, which is herein entirely incorporated by reference. In FIG. 3, a dip tube 1 is coupled to a bushing 4, which may also be coupled to a cup 5. An actuator 6 is also coupled to the bushing 4. An aperture on the actuator 6 forms a nozzle opening 7, in which a dispersing apparatus, such as a nozzle cap or a dispensing tube, may be attached or screwed. A rod 2 is disposed inside the dip tube 1 in a way that allows the rod 2 to move within the dip tube 1 along its length. The actuator 6 is coupled to the top end of the rod 2, so that when the actuator 6 is depressed, the rod 2 moves downward within the dip tube 1. A sealing member 3 is coupled to the bottom end of the rod 2, so that when the rod 2 is in an up position, i.e., the actuator 6 is not depressed, the sealing member 3 forms a tight-seal with the bottom opening of the dip tube 1. However, when the rod 2 is in a down position, i.e., the actuator 6 is depressed, the sealing member 3 exposes the bottom opening of the dip tube 1 to the heavy and particulate material inside the container, and the aerosol within the container will force the texture material through the bottom opening of the dip tube 1, up through the dip tube 1, and out of the container through the nozzle opening 7. In embodiments, the nozzle opening has a diameter of from about 1/16 inch to about ½ inch, or from about 1/16 inch to about ⅜ inch. The heavy and particulate material of the patch composition may be readily dispensed with the disclosed valve assembly. In other embodiments, the nozzle opening is in the form of a slit which allows the sprayed material to fan out from the nozzle opening upon release. In embodiments where the nozzle opening is a slit, the nozzle has from about a 3/16 inch fan to about a ½ inch fan.

The cup 5 acts as a guide to limit how far down the actuator 6 may be depressed, and in turn how far down the rod 2 may travel within the dip tube 1. If the actuator 6 is depressed too far, the bottom end of the rod 2 may come in contact with the bottom surface of the container, which may result in damage to the container. The cup 5 is also adapted to fit securely over the top portion of an aerosol spray can and may also provide a surface for attaching the valve assembly to the aerosol spray can.

The placement of the valve opening at the bottom of the container, as opposed to near the top of the container, as described in the prior references, drastically reduces the clogging and packing of the valve opening as experienced by traditional aerosol spray cans when spraying texture materials containing large particulates, such as roof patch compositions. In addition to being capable of spraying such compositions, the valve assembly is also particularly useful in spraying other types of materials having large particulates or high viscosities. These materials having large particulates or high viscosities may be dispensed directly from the valve system of an aerosol dispensing container. The aerosol dispensing container is preferably a size that allows it to be hand held and may be operated with one hand.

The patch composition used provides a tar-like quality that allows the composition to cover, seal and waterproof the damaged area. The tar-like quality is imparted by a combination of ingredients including an elastomeric resin. For example, an acrylic resin may be used. Acrylic resins are used because of the physical strength such resins impart to the structures the resins are attached to. Acrylic can form very strong bonds and is desirable to use in sealing discovered holes or cracks, especially in the roof because such a surface is constantly exposed to harsh conditions. Furthermore, acrylic resins are waterproof and can seal out moisture. Unlike many bonding agents, acrylic resin is not re-emulsifying. Consequently, once that it has dried, it will not return to a liquid state again and lose its bonding properties regardless of how much water contacts the acrylic resin.

Other adhesive binders may take the form of a natural polymer, such as gums and resins and the like, or a synthetic polymer, such as polyvinyl alcohol, polyvinyl acetate, acrylic polymers, alkyd resins, etc., or a combination thereof. In embodiments, polyurea derivatives such as polyurea, urethane, or polyurea/polyurethane hybrids are also used as the binder. These materials impart good environmental and chemical resistance to the patched area.

A filler be selected from calcium-carbonate (limestone), mica, silica, refined sand or clay. Other fillers may be composed of a mixture of fillers, such as silica and refined sand. Fillers are used to serve as extenders or bodifiers to occupy extra space in the composition. Each individual filler may also be used alone. A sealing agent such as silicone is also included to provide a flexibility to the composition so that, after application to the area of repair, the composition can move into and expand in the crack or leak to properly seal the area. The silicone is waterproof and can provide further protection to effectively seal over the damaged area to keep water out. Other materials with similar characteristics may be used in place of silicone.

A suspension agent is used to thicken the patch composition as well as keep all the ingredients uniformly dispersed and suspended. One suspension agent that may be used with the present embodiments is METHOCEL. METHOCEL cellulose ethers are multifunctional additives for ready-mixes and dry-mix products. The water retention properties of METHOCEL additives increase open time and impart workability and lubricity. In addition, METHOCEL can resist shrinkage and crack formation which is important in repairing roof surfaces. Incorporation of such a suspension agent may also enhance the adhesive properties of the composition so as to provide greater resistance to sagging. Such properties help ensure that the repair will be long lasting and endure under harsh weather conditions.

Lastly, anti-freeze, anti-mold and anti-fungal additives may be included so that the applied composition may better withstand the extreme elements that a rooftop is exposed to constantly. Anti-freeze may be added so that the composition does not freeze and crack in prolonged cold weather. Anti-mold and anti-fungal additives may be added to prevent mold and fungus from developing and growing on or near the area of repair. Because the growth of mold and fungus may weaken the roof surface after some time, including such additives is desirable to maintain integrity and strength of the repaired area.

By way of an example, the roof patch composition 10 of the present invention may have the following composition by percentage weight: an adhesive binder present in an amount of from about 20 percent to about 60 percent, a filler present in an amount of from about 30 percent to about 60 percent, a suspension agent present in an amount of from about 5 percent to about 10 percent, a sealing agent present in an amount of from about 5 percent to about 15 percent, and a propellant present in an amount of from about 10 percent to about 15 percent. Optional additives may also be included, such as color pigments, anti-freeze, anti-fungal agent or anti-mold agent. These additives may be present as follows: color pigment present in an amount of from about 1 percent to about 15 percent or from about 1 percent to about 3 percent, anti-freeze present in an amount of from about 1 percent to about 10 percent or from about 2 percent to about 10 percent, anti-fungal agent present in an amount of from about 1 percent to about 10 percent or from about 1 percent to about 8 percent, and anti-mold agent present in an amount of from about 1 percent to about 10 percent or from about 1 percent to about 8 percent.

A more specific example of the composition 10 comprises an acrylic resin, calcium carbonate, clay, silicon, propellant and optionally, pigments, anti-freeze, anti-fungal additives, and anti-mold additives. The acrylic resin base will serve to provide the composition with a tar-like quality that will keep the composition in place once it has cured. Calcium carbonate and clay are fillers that serve as an extender or bodifier. The sealing agent is preferably silicone and/or resins. Alternatively, an organic sealing agent, or a sealing agent that is a mixture of silicone and an organic, may be used. Other materials with similar characteristics as silicone and resins may also be used as the sealing agent. The suspension agent is preferably carbonal or a cellulose ether, such as METHOCEL.

By way of an example, the composition 10 of the present invention may have the following composition by percentage weight: an acrylic resin present in an amount of from about 20 percent to about 65 percent, calcium carbonate present in an amount of from about 20 percent to about 40 percent, clay present in an amount of from about 20 percent to about 30 percent, liquefied propellant (that mixes with the composition) present in an amount of from about 8 percent to about 15 percent, silicone present in an amount of from about 5 percent to about 15 percent, and METHOCEL present in an amount of from about 2 percent to about 5 percent.

By way of another example, the composition 10 of the present invention may have the following composition by percentage weight: an elastomeric resin present in an amount of from about 20 percent to about 60 percent, calcium carbonate present in an amount of from about 20 percent to about 40 percent, clay present in an amount of from about 10 percent to about 30 percent, dimethyl ether present in an amount of from about 10 percent to about 15 percent, silicone present in an amount of from about 5 percent to about 15 percent, and METHOCEL present in an amount of from about 2 percent to about 10 percent, pigments present in an amount of from about 1 percent to about 15 percent, anti-freeze present in an amount of from about 1 percent to about 8 percent, an anti-fungal agent present in an amount of from about 1 percent to about 10 percent, and an anti-mold agent present in an amount of from about 1 percent to about 10 percent.

While the description above refers to particular embodiments of the present invention, it will be understood that many modifications may be made without departing from the spirit thereof. The accompanying claims are intended to cover such modifications as would fall within the true scope and spirit of the present invention.

The presently disclosed embodiments are, therefore, to be considered in all respects as illustrative and not restrictive, the scope of the invention being indicated by the appended claims rather than the foregoing description. All changes that come within the meaning of and range of equivalency of the claims are intended to be embraced therein.

What is claimed is:

1. An aerosol roof patch composition for application to a roof surface to be repaired, comprising:
an adhesive binder present in the roof patch composition in an amount of from about 20 percent to about 60 by percentage weight of the total composition weight, the binder being selected to adhere the roof patch composition to an area of repair;
a sealing agent present in the roof patch composition in an amount of from about 5 percent to about 15 by percentage weight of the total composition weight, the sealing agent being selected to seal and expand in the area of repair;
a filler present in the roof patch composition in an amount of from about 30 percent to about 60 by percentage weight of the total composition weight;
a suspension agent present in the roof patch composition in an amount of from about 5 percent to about 10 by percentage weight of the total composition weight; and
a color pigment present in the roof patch composition in an amount of from about 1 percent to about 15 by percentage weight of the total composition weight.

2. The roof patch composition of claim 1, wherein the adhesive binder is selected from a group consisting of an elastomeric acrylic resin, polyurea, polyurea derivatives and mixtures thereof.

3. The roof patch composition of claim 1, where in the adhesive binder is urethane.

4. The roof patch composition of claim 1, wherein the sealing agent is selected from the group consisting of silicone, resin and mixtures thereof.

5. The roof patch composition of claim 1, wherein the filler is selected from the group consisting of calcium-carbonate, mica, clay and mixtures thereof.

6. The roof patch composition of claim 1, wherein the filler is selected from the group consisting of silica, fine sand and mixtures thereof.

7. The roof patch composition of claim 1, wherein the suspension agent is selected from the group consisting of METHOCEL, carbonal and mixtures thereof.

8. The roof patch composition of claim 1, wherein the color pigment is present in an amount of from about 1 percent to about 3 by percentage weight of the total composition weight

9. The roof patch composition of claim 1, wherein the color pigment is selected from the group consisting of gray, white, pink, black, brown and mixtures thereof.

10. The roof patch composition of claim 1, wherein the propellant is present in an amount of from about 8 percent to about 15 by percentage weight of the total composition weight.

11. The roof patch composition of claim 1, wherein the propellant is dimethyl ether.

12. The roof patch composition of claim 1, wherein the propellant is selected from the group consisting of hydrocarbon, propane, butane, carbon dioxide, nitrogen, compressed gas and mixtures thereof.

13. The roof patch composition of claim 1 further including an anti-freeze agent present in an amount of from about 1 percent to about 10 by percentage weight of the total composition weight.

14. The roof patch composition of claim 1 further including an anti-fungal agent present in an amount of from about 1 percent to about 10 by percentage weight of the total composition weight.

15. The roof patch composition of claim 1 further including an anti-mold agent present in an amount of from about 1 percent to about 10 by percentage weight of the total composition weight.

16. A roof patch composition for application to a roof surface to be repaired, comprising:
an adhesive binder present in the roof patch composition in an amount of from about 20 percent to about 60 by percentage weight of the total composition weight, the binder being selected to adhere the roof patch composition to an area of repair;
a sealing agent present in the roof patch composition in an amount of from about 5 percent to about 15 by percentage weight of the total composition weight, the sealing agent being selected to seal and expand in the area of repair;
a filler present in the roof patch composition in an amount of from about 30 percent to about 60 by percentage weight of the total composition weight;
a suspension agent present in the roof patch composition in an amount of from about 5 percent to about 10 by percentage weight of the total composition weight; and
a color pigment present in the roof patch composition in an amount of from about 1 percent to about 15 by percentage weight of the total composition weight,
wherein the roof patch composition is stored in an aerosol fluid-tight dispensing container further including a valve assembly and a propellant for spraying the roof patch composition onto the area of repair to form a waterproof seal thereon, the valve assembly further comprising
a dip tube with a top opening and a bottom opening, wherein the dip tube is at least primarily disposed inside the container,
a rod with a top end and a bottom end that is adapted to move lengthwise within the dip tube, wherein the rod is at least primarily disposed within the dip tube,
a sealing member coupled to the bottom end of the rod, forming a tight-seal with the bottom opening of the dip tube when the rod is in an up position, and opening the bottom opening of the dip tube when the rod is in a down position,
a resilient member having a first end and a second end, wherein the first end engages the container and wherein the second end engages the sealing member, and
an actuator with an aperture forming a nozzle opening, and wherein the depression of the actuator causes the rod to lower, thereby opening the bottom opening of the dip tube and allowing the roof patch composition to flow into the dip tube and out of the nozzle.

17. An aerosol system comprising
an aerosol fluid-tight dispensing container having a top end and a bottom end;
a roof patch composition contained therein, further comprising
an adhesive binder present in the roof patch composition in an amount of from about 20 percent to about 60 by percentage weight of the total composition weight, the binder being selected to adhere the roof patch composition to an area of repair,
a sealing agent present in the roof patch composition in an amount of from about 5 percent to about 15 by percentage weight of the total composition weight, the sealing agent being selected to seal and expand in the area of repair,
a filler present in the roof patch composition in an amount of from about 30 percent to about 60 by percentage weight of the total composition weight,
a suspension agent present in the roof patch composition in an amount of from about 5 percent to about 10 by percentage weight of the total composition weight,
a color pigment present in the roof patch composition in an amount of from about 1 percent to about 15 by percentage weight of the total composition weight, and
a propellant present in the roof patch composition in an amount of from about 8 percent to about 15 by percentage weight of the total composition weight; and
a valve assembly that sprays the roof patch composition from the container to a roof surface to be repaired, the valve assembly further comprising
a dip tube with a top opening and a bottom opening, wherein the dip tube is at least primarily disposed inside the container,
a rod with a top end and a bottom end that is adapted to move lengthwise within the dip tube, wherein the rod is at least primarily disposed within the dip tube,
a sealing member coupled to the bottom end of the rod, forming a tight-seal with the bottom opening of the dip tube when the rod is in an up position, and opening the bottom opening of the dip tube when the rod is in a down position,
a resilient member having a first end and a second end, wherein the first end engages the container and wherein the second end engages the sealing member, and
an actuator with an aperture forming a nozzle opening, and wherein the depression of the actuator causes the rod to lower, thereby opening the bottom opening of the dip tube and allowing the roof patch composition to flow into the dip tube and out of the nozzle.

18. The aerosol system of claim 17, wherein the color pigment is selected from the group consisting of gray, white, pink, black, brown and mixtures thereof.

19. The aerosol system of claim 17, wherein the nozzle opening has a diameter of from about 1/16 inch to about ½ inch.

20. The aerosol system of claim 17, wherein the nozzle opening has a diameter of from about 1/16 inch to about ⅜ inch.

21. The aerosol system of claim 17, wherein the nozzle opening is shaped as a slit having from about a 3/16 inch fan to about a ½ inch fan.

22. The aerosol system of claim 17, wherein the adhesive binder is an elastomeric acrylic resin, polyurea, polyurea derivatives and mixtures thereof.

23. The aerosol system of claim 17, wherein the sealing agent is being selected from the group consisting of silicone, resin and mixtures thereof.

24. The aerosol system of claim 17, wherein the filler is selected from the group consisting of calcium-carbonate, mica, clay and mixtures thereof.

25. The aerosol system of claim 17, wherein the filler is selected from the group consisting of silica, fine sand and mixtures thereof.

26. The aerosol system of claim 17, wherein the suspension agent is selected from the group consisting of METHOCEL, carbonal and mixtures thereof.

27. The aerosol system of claim 17, wherein the propellant is present in the roof patch composition in an amount of from about 10 to about 15 by percentage weight of the total composition weight.

28. The aerosol system of claim 17, wherein the propellant is dimethyl ether.

29. The aerosol system of claim 17, wherein the propellant is selected from the group consisting of hydrocarbon, propane, butane, carbon dioxide, nitrogen, compressed gas and mixtures thereof.

30. The aerosol system of claim 17 further including an anti-freeze agent present in an amount of from about 1 to about 10 by percentage weight of the total composition weight.

31. The aerosol system of claim 17 further including an anti-fungal agent present in an amount of from about 1 to about 10 by percentage weight of the total composition weight.

32. The aerosol system of claim 17 further including an anti-mold agent present in an amount of from about 1 to about 10 by percentage weight of the total composition weight.
